(19) United States
(12) Patent Application Publication
(10) Pub. No.: US 2005/0005865 A1
(43) Pub. Date: Jan. 13, 2005

(54) Bird feeder

(76) Inventors: Christopher T. Rich, Lancaster, PA (US); Clay E. Tully, Lancaster, PA (US); Carina Uhle, Atlanta, GA (US)

Correspondence Address: JACOBSON HOLMAN PLLC, 400 SEVENTH STREET N.W., SUITE 600, WASHINGTON, DC, 20004, US

(21) Appl. No.: 10/823,766

(22) Filed: Apr. 14, 2004

Related U.S. Application Data
(60) Provisional application No. 60/462,297, filed on Apr. 14, 2003.

(51) Int. Cl. A01K 39/01

(52) U.S. Cl. 119/52.2

(57) ABSTRACT

A bird feeder includes a hopper having a transparent shell with a spiral internal divider which forms segregated spiral compartments to feed a plurality of different types of bird food. A coupler having segregated vertical chambers, each aligned with an exit end of each segregated spiral compartment, directs the bird food from the hopper to separate feed openings. A seed catcher is attached underneath the coupler and a domed cap covers the top of the hopper.

This is a complete application claiming benefit of provisional application Ser. No. 60/462,297, filed Apr. 14, 2003.

### BACKGROUND OF THE INVENTION

1. Technical Field

This invention relates to bird feeders and relates more particularly to the type of bird feeder which comprises a tubular housing or hopper for receipt of a quantity of bird food, and a hanger for attaching the housing to a support for the bird feeder, such as a hook, a tree limb or the like. Commonly, the hopper for bird feeders of this type comprise a cylindrical transparent plastic tube with a multiplicity of feed ports or openings adjacent the bottom or intermediate the top and bottom portions of the tube.

2. Discussion of the Prior Art

Commercially available bird feeders commonly comprise a cylindrical hopper or tube to receive and dispense a single type of bird food. For example, the hopper may hold a quantity of black oil sunflower seeds or a quantity of thistle, with the feed openings being sized and shaped accordingly. Oftentimes, such bird feeders will be provided with a seed catcher fed from apertures in the bottom of the hopper and/or adapted to receive bird seed escaping from feed openings in the body of the hopper scattered by birds sitting on perches or the like juxtaposed to the feed openings.

Bird feeders are available with multiple food hoppers or reservoirs, but commercially available products of this nature are often difficult and expensive to manufacture, assemble or use and unattractive in appearance.

### OBJECTS AND SUMMARY OF THE INVENTION

With the foregoing in mind, it is a primary object of this invention to provide a bird feeder designed to receive and dispense several different types of bird food from a single hopper.

Another object of this invention is the provision of a bird feeder hopper comprising a cylindrical shell, preferably of transparent polymeric material, with a spiral internal divider wherein the hopper can be a one-piece extrusion which is simple and inexpensive to manufacture.

Yet another object of this invention is the provision of a multi-seed bird feeder which is simple and inexpensive to manufacture and assemble, and which includes a unique hopper which is unusual and attractive in appearance, particularly if the individual compartments are filled with different types of bird seed.

A further object of this invention is the provision of a bird feeder comprising a transparent tubular hopper which includes an internal spiral or helical divider to separate the feed tube into three or more segregated compartments extending from the top to the bottom of the tube so that different types of bird food can be dispensed by gravity from each compartment to attract a variety of birds to a single feeder.

Another object of this invention is to provide a bird feeder of the type described wherein the hopper is removably secured to a base and to a cover to enable the hopper to be totally separated from the remaining components for cleaning and/or replacement in the event of damage.

A still further object of this invention is the provision of a unique coupler to connect a seed catcher to the hopper, the coupler preferably including a baffle spaced from the seed catcher to divert water and protect feeding birds, and to discourage squirrels from accessing the bird food.

Upon further study of the specification and accompanying drawings, additional objects and advantages of this invention will become apparent to those skilled in the art.

### BRIEF DESCRIPTION OF THE DRAWINGS

These and other objects, features and many of the attendant advantages of this invention will be better understood by those with ordinary skill in the art in connection with the following detailed description of the preferred embodiments and the accompanying drawings wherein like parts in each of the several figures are identified by the same reference characters, and wherein:

FIG. 1 is a front elevational view of a preferred embodiment of a bird feeder according to the instant inventive concepts;

FIG. 2 is a vertical cross-sectional view taken along lines 2-2 of FIG. 1;

FIG. 3 is an enlarged elevational view of the bird feeder hopper, illustrating the spiral divider as seen through the transparent shell in dotted lines;

FIG. 4 is a transverse cross-sectional view taken along lines 4-4 of FIG. 3;

FIG. 5 is a transverse cross-sectional view taken along lines 5-5 of FIG. 1;

FIG. 6 is an enlarged elevational view of the coupler device for connecting the hopper to the seed catcher;

FIG. 7 is a top plan view of the coupler seen in FIG. 6;

FIG. 8 is a vertical cross-sectional view of the coupler taken along lines 8-8 of FIG. 7;

FIG. 8A is an enlarged detail of the portion of FIG. 8 within the dotted circle;

FIG. 9 is a transverse cross-sectional view taken along lines 9-9 of FIG. 6;

FIG. 10 is a top plan view of the seed catcher or tray;

FIG. 11 is a side elevational view of the seed catcher or tray;

FIG. 12 is a transverse cross-sectional view of the seed catcher taken along lines 12-12 of FIG. 10;

FIG. 13 is a detailed cross-sectional view showing the assembled portions of the seed catcher, coupler element and hopper within the dotted circle in FIG. 2;

FIG. 14 is a top plan view of a cap or cover for the hopper;

FIG. 15 is a transverse cross-sectional view through the cap taken along lines 15-15 of FIG. 14; and

FIG. 16 is an enlarged detailed view of the hanging wire assembly for the bird feeder of this invention, partially broken away for illustrative convenience.

### DETAILED DESCRIPTION OF THE PREFERRED EMBODIMENTS

The foregoing descriptions and drawings should be considered as illustrative only of the principles of the invention. Numerous applications of the present invention will readily occur to those skilled in the art. Therefore, it is not desired to limit the invention to the preferred embodiments or the exact construction and operation of the preferred apparatus shown and described. Rather, all suitable modifications and equivalents may be resorted to, falling within the scope of the invention. Further, although the drawings serve to illustrate the present invention, they are not intended to be drawn to scale.

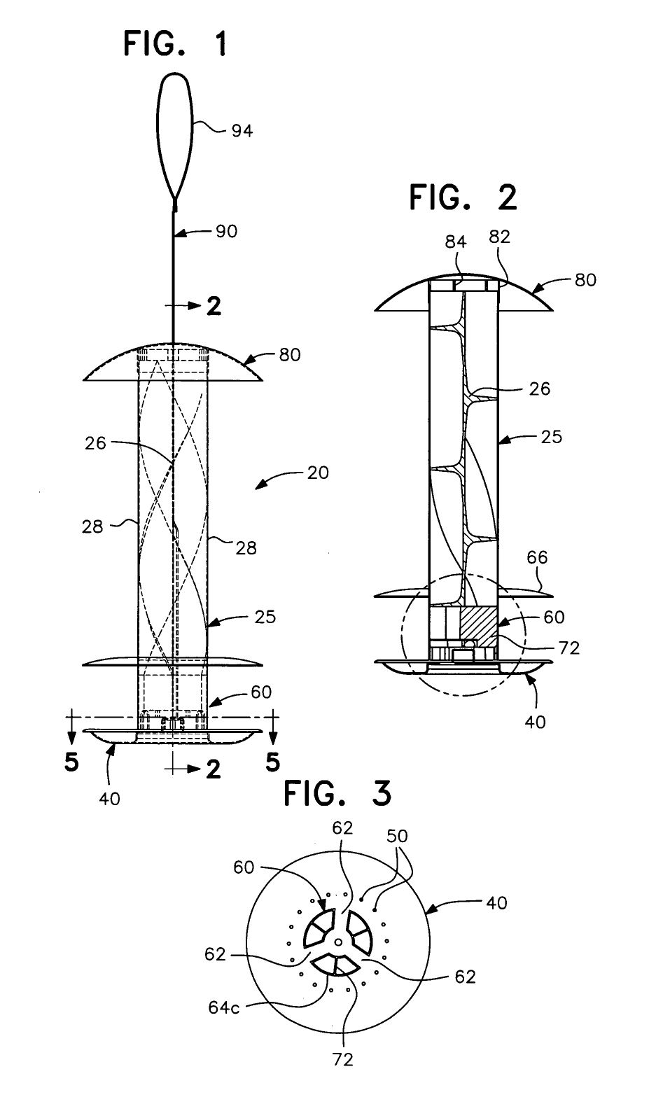

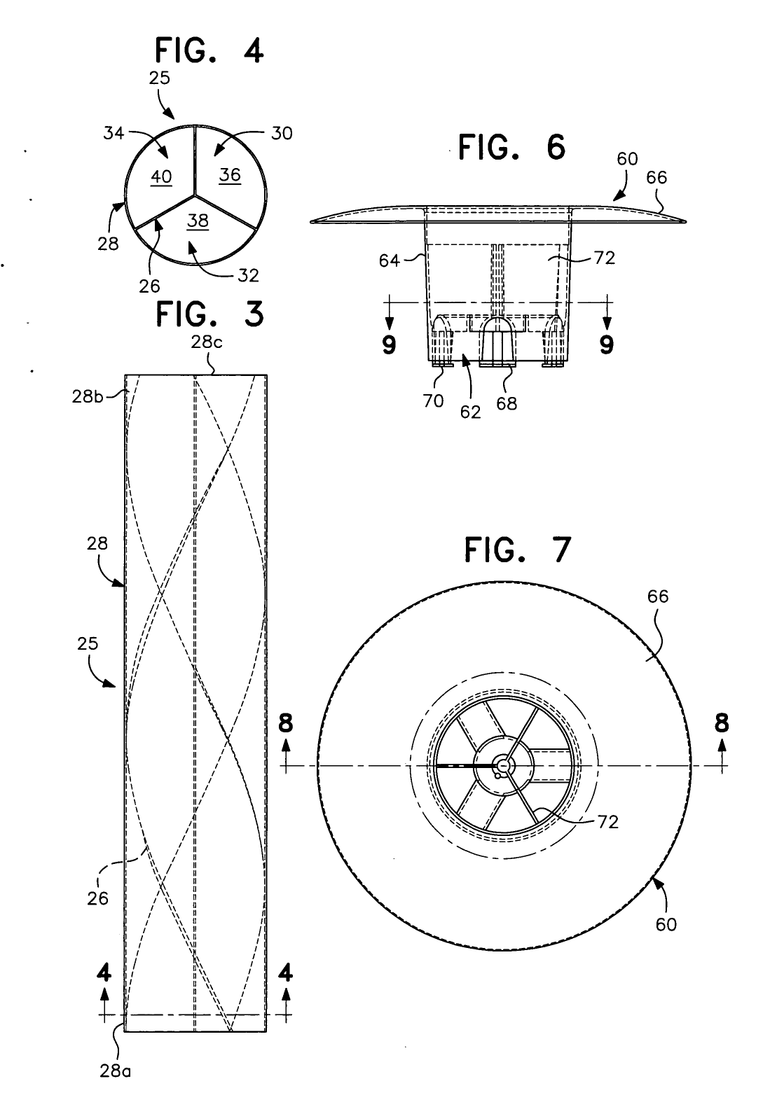

Referring now to the drawings, a preferred embodiment of a bird feeder according to the instant inventive concepts is designated generally by the reference numeral 20 and is comprised basically of five components, a main component being an elongated tubular hopper 25 seen in detail in FIGS. 3 and 4 and in cross-section in FIG. 2, having an integrally extruded spiral or helical divider 26 internally of a cylindrical shell 28, preferably formed of a transparent plastic material so that the divider 26 and the bird food contained within the hopper 25 are visible therethrough. The illustrated divider 26 forms preferably three separate compartments 30, 32 and 34 which are defined by ramps 36, 38 and 40 extending the full length of the shell 28, although the spiral divider can be formed to provide only two compartments or more than three compartments, as many as ten or more, in an obvious manner.

A second component of the bird feeder 20 is a seed catcher 40 seen particularly in FIGS. 10 and 11, and in cross-section in FIG. 12. The seed catcher 40 comprises an upstanding central hub 42 with an outwardly extending peripheral portion 44 having slots 46 for a purpose to be described below, and a dished area 48 for catching bird food, such as seeds or the like, in a well known manner. A multiplicity of through openings 50 may be provided to permit rainwater or the like to escape from the dished area 48.

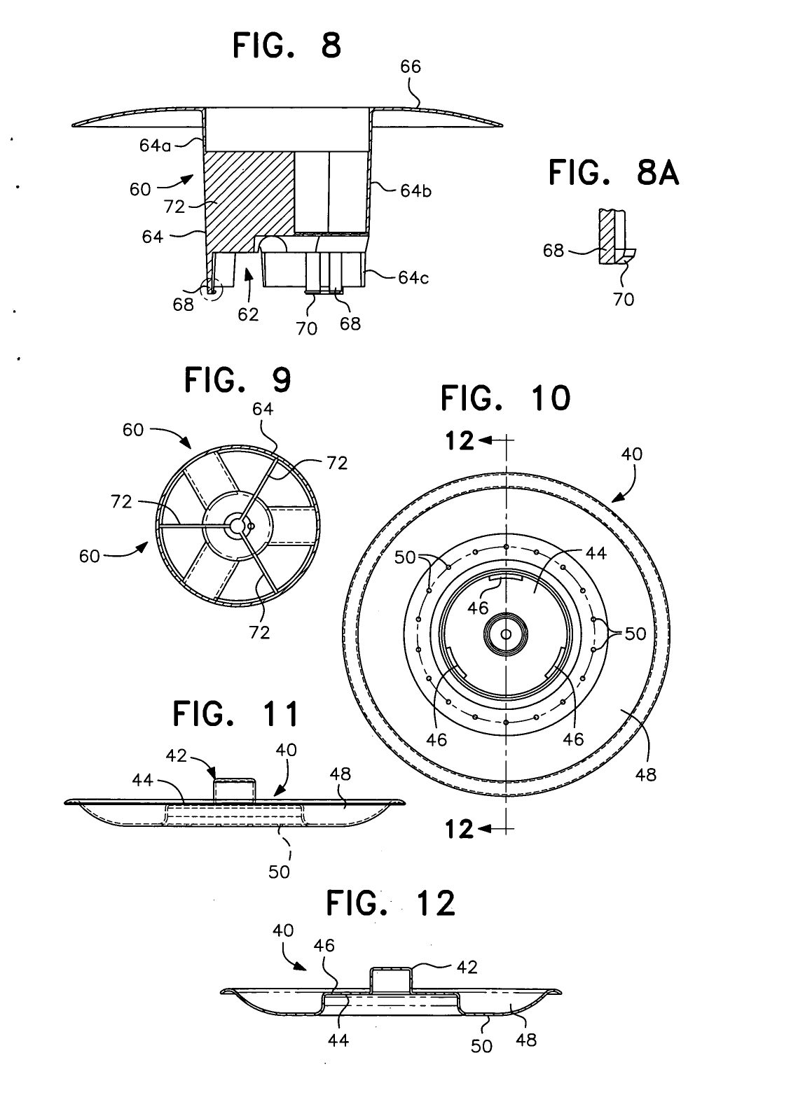

A third component of the bird feeder 20 is a coupler element 60 seen particularly in FIGS. 6 and 7, and in cross-section in FIGS. 8 and 9. The coupler 60 is designed to interconnect the hopper 25 with the seed catcher 40 by press-fit engagement and to direct bird food from the individual compartments 36, 38 and 40 of the hopper 25 to a series of apertures or feed openings 62 defined at the lower portion of a central hub 64. An outstanding baffle 66 may be provided at the top of the hub 64 as illustrated.

A series of downwardly depending elements 68 are formed about the lower periphery of the hub 64, with inwardly extending flanges 70 as seen in detail in FIG. 8A to lockingly engage the coupler 60 in the slots 46 of the seed catcher 40.

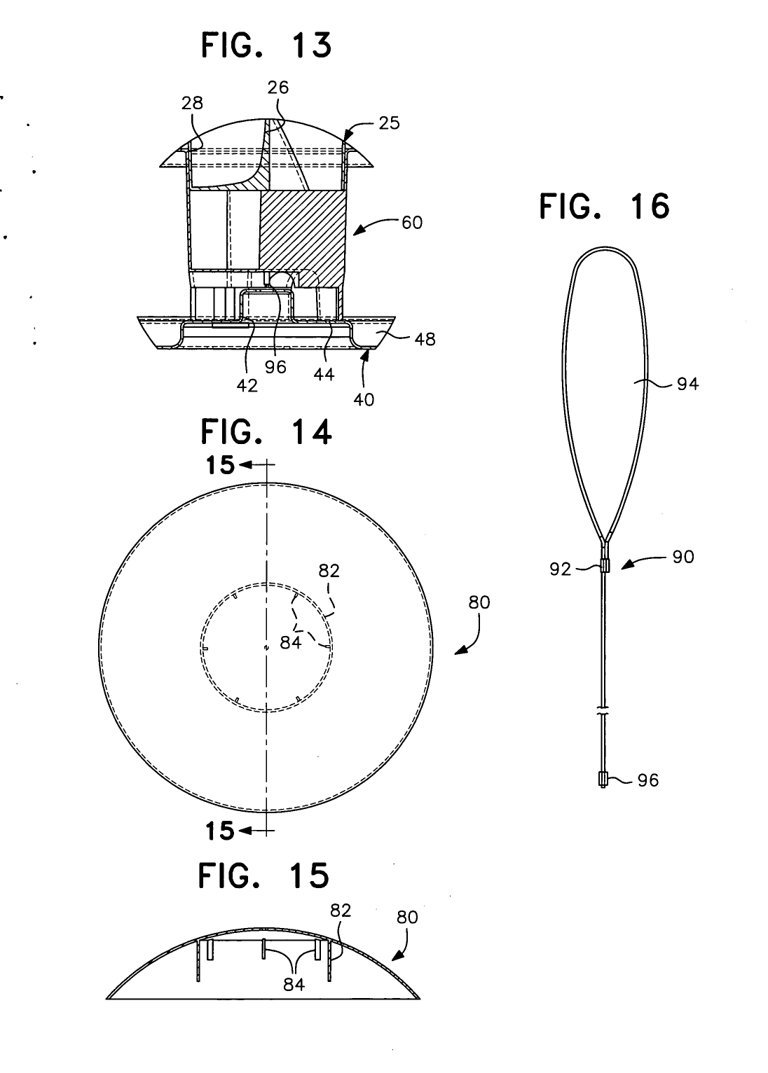

The upper portion 64a of the hub 64 of the coupler element 60 is adapted to frictionally receive and hold the lower portion 28a of the hopper 25 in the manner seen particularly in FIG. 13, and the dividers 72 within the middle portion 64b of the hub 64 divide the coupler element 60 into three vertically segregated, pie-shaped chambers 73. The chambers 73 direct the bird food, which is fed by gravity from the individual compartments 36, 38 and 40 of the hopper 25, to the respective feed openings 62 and, ultimately, to the dished portion 48 of the seed catcher 40.

A partial assembly view of the seed catcher 40, coupler element 60 and hopper 25 is seen in FIG. 13 and the fully assembled view is seen in FIGS. 1 and 2, wherein it will be recognized that the baffle 66 of the coupler element 60 functions to divert rain or the like from birds feeding at the aperture 62 or from the seed catcher dished portion 48 and, additionally, makes it somewhat more difficult for squirrels to access the bird food.

A fourth component of the bird feeder 20 is a domed cap or cover 80 seen particularly in FIGS. 14 and 15, which includes a downwardly depending circular flange 82 adapted to removably fit about the upper portion 28b of the shell 28 of the hopper 25, with a series of inwardly extending flanges 84 which sit on the upper edge 28c of the shell 28.

Finally, a hanger or carrier 90 may be provided as seen in FIG. 16, the end of which is crimped back on itself at 92 to form a loop 94 for hanging the bird feeder 20 from any desired support. The lower end of the hanger 90 may pass through the hopper 25 and have a crimped element 96 to secure the same below portions of the coupler element 60 or the like.

The particularly unique aspects of the spiral or helical hopper 25 enables the cost-effective production of this element as a single twisted extrusion. Moreover, the spiral ramps 36, 38 and 40 provide a smooth gravity flow of different forms of bird food from the top to the bottom of the hopper 25 and, ultimately, through the feed opening 62 in the coupler element 60. Obviously, although the three compartments can be filled with the same bird food, the ability to provide independent compartments 36, 38, 40 for different forms of bird food not only enables the attraction of different types of bird to a single feeder, but also provides a unique appearance as the different bird foods are viewed through the shell 28 of the hopper 25.

Although the particular design disclosed and described herein wherein the spiral hopper 25 is adapted to provide feed at its lower extremity 28a through the unique coupler element 60, the spiral hopper concept could be adapted for use in bird feeders of a different design. For example, a multiplicity of vertically-spaced feed openings (not shown) can be provided in a well known manner intermediate the top and the bottom of the shell of the hopper, communicating with the individual compartments and, if desired, juxtaposed to perches carried by the hopper. In this manner, different types of bird can feed along the length of the hopper from the bird food in the different compartments.

It is believed that those with ordinary skill in the art can readily produce the hopper, coupler, seed catcher and cap elements of the bird feeder of this invention from any suitable plastics material using well known manufacturing techniques. Moreover, the shape and dimensions of the individual elements are not critical to the instant inventive concepts and can be varied to suit particular applications.

Thus, the foregoing descriptions and drawings should be considered as illustrative only of the principles of the invention. Numerous applications of the present invention will readily occur to those skilled in the art. Therefore, it is not desired to limit the invention to the preferred embodiments or the exact construction and operation of the preferred device shown and described. Rather, all suitable modifications and equivalents may be resorted to, falling within the scope of the invention.

1. A bird feeder comprising:
a generally cylindrical housing having a top and a bottom;
a spiral divider positioned vertically in said housing to divide said housing into at least two spiral compartments for holding bird seed which compartments extend continuously from adjacent said housing top to adjacent said housing bottom;
a cover for said housing top; and
a base for said housing bottom having at least two vertically segregated feed chambers each with separate feed openings, each feed chamber communicating with one of said spiral compartments for seed to separately exit each said spiral compartment through a respective feed chamber and out its opening.

2. The bird feeder in accordance with claim 1, wherein said spiral divider divides said housing into three compartments and said base has three corresponding feed chambers.

3. The bird feeder in accordance with claim 1, wherein said housing and said spiral divider are made of transparent plastic.

4. The bird feeder in accordance with claim 3, wherein said housing and said spiral divider are made as a single twisted extrusion.

5. The bird feeder in accordance with claim 1, wherein said vertically segregated feed chambers are defined by radially extending dividers in a cylindrical coupler connected to said housing bottom.

6. The bird feeder in accordance with claim 5, wherein said coupler includes an upper end and a lower end and said base also includes a seed catcher attached to said lower end of the coupler to define a lowermost side of said feed openings.

7. The bird feeder in accordance with claim 6, wherein the upper end of said coupler is frictionally engaged with the bottom of said housing.

8. The bird feeder in accordance with claim 7, wherein said coupler includes an exterior baffle adjacent its upper end which serves to protect birds feeding on said seed catcher.

9. The bird feeder in accordance with claim 6, wherein the lower end of said coupler includes downwardly depending elements with generally horizontally extending flanges which lockingly engage in corresponding slots of the seed catcher to retain said seed catcher in position underneath said coupler.

10. The bird feeder in accordance with claim 1, wherein said cover for said housing top includes a domed cap with an integral downwardly depending circular flange which removably engages said housing top.

11. The bird feeder in accordance with claim 1, wherein said housing, said spiral divider, said cover and said base are all made from plastic materials.

12. A bird feeder comprising:
a generally cylindrical plastic housing divided into a plurality of spiral compartments which extend continuously from a top of said housing to a bottom of said housing;
a cap covering said top of the plastic housing;
a cylindrical coupler having an upper end frictionally engaged with said bottom of the plastic housing and having dividers which define vertically segregated coupler chambers each separately aligned with an exit of one of said plastic housing spiral compartments to direct seeds separately from each of said spiral compartments to an individual feed opening associated with each coupler chamber; and
a seed catcher connected to the lower end of said coupler on which birds may perch to eat seeds exiting from said coupler openings.

13. The bird feeder in accordance with claim 12, wherein said coupler dividers are generally vertical and equally spaced radially around said cylindrical coupler.

14. The bird feeder in accordance with claim 12, wherein said seed catcher includes a dished area radially outward of said cylindrical coupler for catching bird food which exits from said openings.

15. The bird feeder in accordance with claim 12, wherein said seed catcher is connected to said coupler by depending flanges from said coupler inserted into corresponding slots in said seed catcher.

16. The bird feeder in accordance with claim 12, wherein said seed catcher includes an upstanding central hub adapted to receive a cylindrical mounting post for supporting said bird feeder.

17. The bird feeder in accordance with claim 12, further comprising a carrier for said bird feeder which extends above said cap and includes a component which extends through said cap and said plastic housing and is connected to said coupler or said seed catcher to hang said bird feeder for support.

18. The bird feeder in accordance with claim 12, wherein said plastic housing is transparent.

19. The bird feeder in accordance with claim 12, wherein said plastic housing is divided into three spiral compartments and said coupler is divided in three segregated chambers.

20. The bird feeder in accordance with claim 14, wherein the seed catcher includes through openings to permit rainwater or the like to escape from said dished area.
